(19) United States
(12) Patent Application Publication
(10) Pub. No.: US 2022/0094023 A1
(43) Pub. Date: Mar. 24, 2022

(54) SECONDARY BATTERY

(71) Applicant: Panasonic Intellectual Property Management Co., Ltd., Osaka-shi, Osaka (JP)

(72) Inventors: Yuma Kamiyama, Osaka (JP); Shigeki Matsuta, Hyogo (JP); Yoshiaki Araki, Hyogo (JP)

(73) Assignee: Panasonic Intellectual Property Management Co., Ltd., Osaka-shi, Osaka (JP)

(21) Appl. No.: 17/420,165

(22) PCT Filed: Nov. 27, 2019
(86) PCT No.: PCT/JP2019/046296

§ 371 Date: Jul. 1, 2021

(30) Foreign Application Priority Data
Jan. 15, 2019 (JP) 2019-004568

(51) Int. Cl. H01M 50/533; H01M 10/0585; H01M 50/147; H01M 50/543; H01M 50/183

(52) U.S. Cl. CPC H01M 50/533; H01M 10/0585; H01M 50/183; H01M 50/543; H01M 50/147

(57) ABSTRACT

A secondary battery according to an aspect of the present disclosure includes a multilayer electrode body obtained by laminating multiple electrode plates with a separator interposed in between, multiple electrode tabs protruding from first ends of the multiple electrode plates, an exterior body having an opening receiving the multilayer electrode body, a sealing plate that closes the opening, a collector disposed on the sealing plate and connected to the multiple electrode tabs with a connector, and a binding member that binds the multiple electrode tabs between the connector and the multilayer electrode body. A secondary battery with this structure prevents damages of electrode tabs due to abrasion between the electrode tabs.

### TECHNICAL FIELD

The present disclosure relates to a secondary battery.

### BACKGROUND ART

An electrode body accommodated in an exterior body secondary battery may move inside the exterior body in response to vibrations or shocks from the exterior. Patent Document 1 discloses a method for fixing the electrode body to the exterior body with spacers inter Posed at the side surfaces of the electrode body to prevent lamination misalignment where positive elect ode plates and negative electrode plates in a multilayer secondary battery are misaligned from each other.

### CITATION LIST

### Patent Literature

Patent Document 1: International Publication No. 2010/113271

### SUMMARY OF INVENTION

### Technical Problem

Some of multilayer secondary Batteries have a structure including multiple electrode tabs protruding from the electrode body to hold the electrode body in a hanging manner. Such a multilayer secondary battery with this structure has been revealed to be breakable with vibrations or shocks from the exterior. An object of the present disclosure is to provide a secondary battery that prevents breakage of electrode tabs.

### Solution to Problem

A secondary battery according to an aspect of the present disclosure includes a multilayer electrode body obtained by laminating multiple electrode plates with a separator interposed in between, multiple electrode tabs protruding from first ends of the multiple electrode plates, an exterior body having an opening receiving the multilayer electrode body, a sealing plate that closes the opening, a collector disposed on the sealing plate and connected to the multiple electrode tabs with a connector, and a binding member that binds the multiple electrode tabs between the connector and the multilayer electrode body.

### Advantageous Effects of Invention

An aspect of the present disclosure can prevent breakage of electrode tabs.

### BRIEF DESCRIPTION OF DRAWINGS

FIG. 1 is a perspective view of a rectangular secondary battery, which is an example of an embodiment.

FIG. 2 is a cross-sectional view of the secondary battery taken along line A-A in FIG. 1.

FIG. 3 is a perspective view of a multilayer electrode body, which is an example of an embodiment.

FIG. 4 is an enlarged cross-sectional view of a portion around a positive electrode tab in FIG. 2.

FIG. 5 is an enlarged cross-sectional view of a portion around a positive electrode tab in a cross section taken along line B-B in FIG. 2.

### DESCRIPTION OF EMBODIMENTS

The study of inventors of this application has revealed that a multilayer secondary battery having a structure including electrode tabs holding an electrode body in a hanging manner may render the electrode tabs broken by vibrations or shocks from the exterior. As disclosed in Patent Document 1, the structure including the spacers interposed at the side surfaces of the electrode body to fix the electrode body to the exterior body hinders smooth insertion of the electrode body into the exterior body. In recent years, batteries have been increasing the capacity, and thus significantly change the size of the electrode body between when charged and discharged. Thus, the electrode body fixed to the exterior body may suffer compressive stress or tensile stress while being charged or discharged, and may be deformed to cause an internal short-circuit. The inventors of the present application thus have studied a method for preventing damages on electrode tabs due to vibrations or shocks from the exterior, and have invented a secondary battery according to an aspect of the present disclosure.

A secondary battery according to an aspect of the present disclosure includes a multilayer electrode body obtained by laminating multiple electrode plates with a separator interposed in between, multiple electrode tabs protruding from first ends of the multiple electrode plates, an exterior body having an opening receiving the multilayer electrode body, a sealing plate that closes the opening, a collector disposed on the sealing plate and connected to the multiple electrode tabs with a connector, and a binding member that binds the multiple electrode tabs between the connector and the multilayer electrode body.

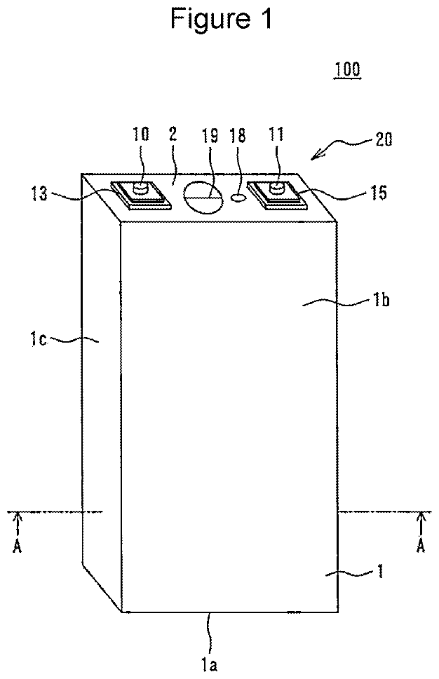

An example of an embodiment will be described in detail. Herein, the longitudinal direction in FIGS. 1 to 5 is referred to as “a vertical direction”.

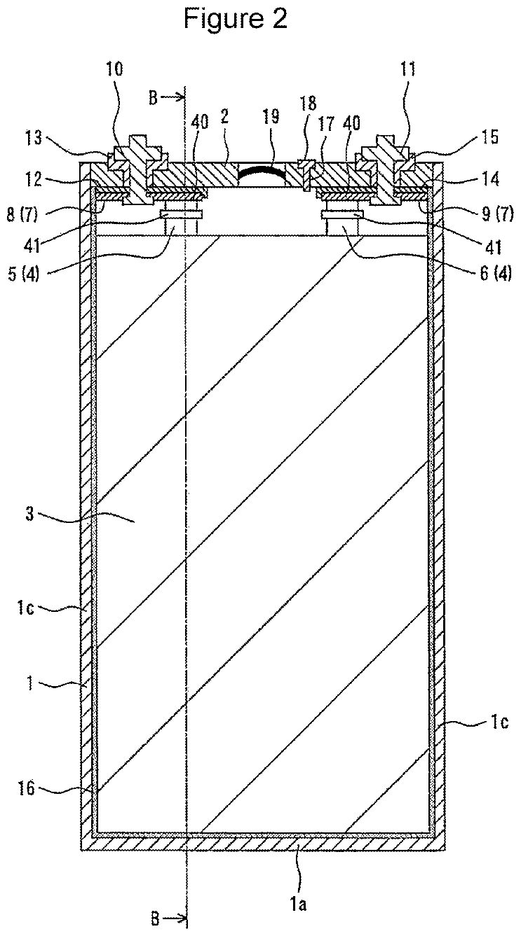

With reference to FIGS. 1 and 2, a structure of a secondary battery 100, which is an example of an embodiment, will be described. FIG. 1 is a perspective view of the external appearance of the secondary battery 100, which is an example of an embodiment. FIG. 2 is a cross-sectional view taken in the vertical direction including line A-A in FIG. 1. As illustrated in FIGS. 1 and 2, the secondary battery 100 includes a battery case 20 including an exterior body 1 having an opening, and a sealing plate 2 that closes the opening. The exterior body 1 and the sealing plate 2 are preferably formed from metal, for example, aluminium or an aluminium alloy. The exterior body 1 is a closed-bottom rectangular cylindrical exterior body that includes a bottom portion 1a, a pair of larger side walls 1b, and a pair of smaller side walls 1c, and that has an opening at a position opposing the bottom portion 1a. The secondary battery 100 illustrated in FIG. 1 is an example of a rectangular secondary battery including a rectangular exterior body 1 (the rectangular battery case 20). The secondary battery of the present embodiment is not limited to this, but may be, for example, a cylindrical secondary battery including a cylindrical exterior body (cylindrical battery case) or a laminate secondary battery including a laminate exterior body (laminate battery case) formed by laminating resin sheets. The sealing plate 2 is connected to the opening edge of the rectangular exterior body 1 by, for example, laser welding.

The sealing plate 2 has an electrolyte injection hole 17. The electrolyte injection hole 17 is stopped up by a stopcock 18 after having an electrolyte, described below, injected therethrough. The sealing plate 2 includes a gas exhaust valve 19. The gas exhaust valve 19 operates in response to the pressure inside the battery reaching or exceeding a predetermined value to discharge the gas inside the battery to the outside.

A positive electrode terminal 10 is attached to the sealing plate 2 to protrude outward from the battery case 20. Specifically, the positive electrode terminal 10 is received in a positive-electrode-terminal receiving hole formed in the sealing plate 2. The positive electrode terminal 10 is attached to the sealing plate 2 while being electrically insulated from the sealing plate 2 with an external insulating member 13 and an internal insulating member 12. The external insulating member 13 is disposed on the battery outer side of the positive-electrode-terminal receiving hole The internal insulating member 12 is disposed on the battery inner side of the positive-electrode-terminal receiving hole. The positive electrode terminal 10 is electrically connected to a positive electrode collector 3 inside the battery case 20. The positive electrode collector 3 is disposed on the sealing plate 2 with the internal insulating member 12 interposed in between. The internal insulating member 12 and the external insulating member 13 are preferably formed from resin.

In addition, a negative electrode terminal 11 is attached to the sealing plate 2 to protrude outward from the battery case 20. Specifically, the negative electrode terminal 11 is received in a negative-electrode-terminal receiving hole formed in the sealing plate 2. The negative electrode terminal 11 is attached to the sealing plate 2 while being electrically insulated from the sealing plate 2 with an external insulating member 15 and an internal insulating member 14. The external insulating member 15 is disposed on the battery outer side of the negative-electrode-terminal receiving hole. The internal insulating member 14 is disposed on the battery inner side of the negative-electrode-terminal receiving hole. The negative electrode terminal 11 is electrically connected to a negative electrode collector 9 inside the battery case 20. The negative electrode collector 9 is disposed on the sealing plate 2 with the internal insulating member 14 interposed in between. The internal insulating member 14 and the external insulating member 15 are preferably formed from resin.

The secondary battery 100 includes a multilayer electrode body 3 and an electrolyte. The exterior body 1 accommodates the multilayer electrode body 3 and the electrolyte. As will be described later, the multilayer electrode body 3 has a multilayer structure where positive electrode plates 31 and negative electrode plates 32 are laminated with separators 33 interposed therebetween. Positive electrode tabs 5 and negative electrode tabs 6 respectively protrude from the positive electrode plates 31 and the negative electrode plates 32 from an upper portion of the multilayer electrode body 3. The positive electrode tabs 5 and the negative electrode tabs 6 are respectively connected to the positive electrode collector 8 and the negative electrode collector 9 with a connector 40 by, for example, welding. Each group of the positive electrode tabs 5 and the negative electrode tabs 6 is bound by a binding member 41 between the connector 40 and the multilayer electrode body 3.

The secondary battery 100 may include an insulating sheet 16 between the multilayer electrode body 3 and the exterior foody 1. As in the case of, for example, the exterior foody 1, the insulating sheet 16 has an open-top closed-bottom box or bag shape. The insulating sheet 16 having an open-top closed-bottom box or bag shape enables insertion of the multilayer electrode body 3 through the opening of the insulating sheet 16 and covering of the multilayer electrode body 3 with the insulating sheet 16.

The material of the insulating sheet 16 may be any material having electric insulation properties, chemical stability resistant to an electrolyte, and electrical stability resistant to electrolysis under a voltage of the secondary battery 100. Examples usable as the material of the insulating sheet 16 include resin materials such as polyethylene, polypropylene, and polyfluoroethylene in view of industrial versatility, manufacturing costs, and quality stability. The shape of the insulating sheet 16 is not limited to a case shape such as the above-described box or bag shape, for example, a flat insulating sheet 16 extending in two directions including a lateral direction and a longitudinal direction may be wound around the multilayer electrode body 3 in two directions of the lateral direction and the longitudinal direction. Thus, the flat insulating sheet 16 can cover the multilayer electrode body 3.

The electrolyte includes a solvent and an electrolyte salt dissolved in the solvent. Examples usable as the solvent include a nonaqueous solvent and an aqueous solvent. When including a nonaqueous solvent, the electrolyte is a nonaqueous electrolyte. Examples usable as a nonaqueous solvent include carbonates, esters, ethers, nitrile, amides, and a mixed solvent including two or more of these. Examples usable as carbonates include cyclic carbonates such as an ethylene carbonate (EC), a propylene carbonate (PC), a butylene carbonate, a vinylene carbonate, and chain carbonates such as a dimethyl carbonate (DMC), an ethyl methyl carbonate (EMC), a diethyl carbonate (DEC), a methyl propyl carbonate, an ethyl propyl carbonate, and a methyl isopropyl carbonate. The nonaqueous solvent may contain a halogen substitute obtained by substituting at least part of hydrogen of the solvent with a halogen atom of, for example, fluorine. Instead of a liquid electrolyte, the electrolyte may be a solid electrolyte formed from a gel polymer. The electrolyte salt includes lithium salt. For example, LiPF₆ generally used as a supporting electrolyte in the existing secondary battery 100 may be used as the lithium salt. An additive such as vinylene carbonate (VC) may be added as appropriate.

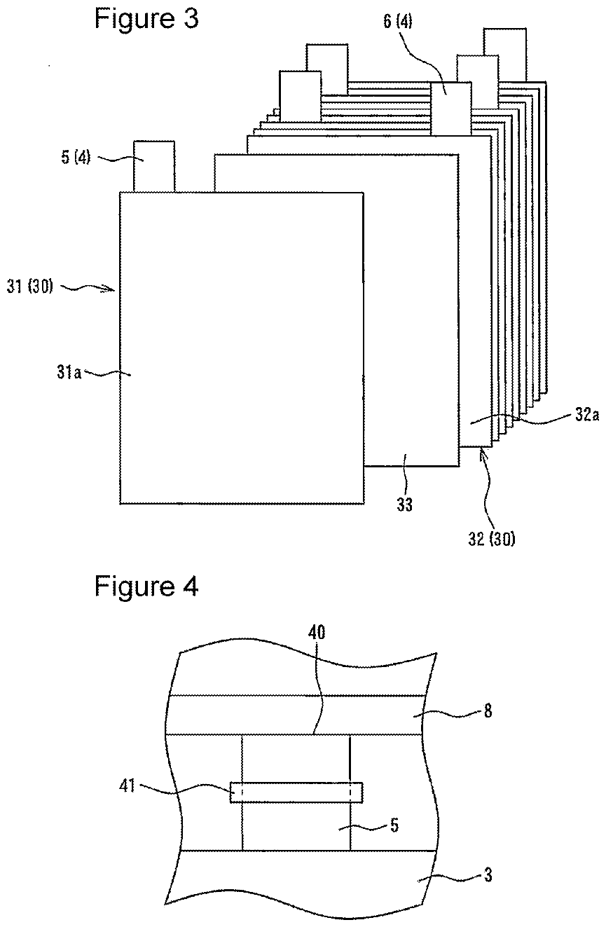

Now, the multilayer electrode body 3 and electrode tabs 4 (the positive electrode tabs 5 and the negative electrode tabs 6) will be described in detail with reference to FIG. 3. The multilayer electrode body 3 has a multilayer structure where multiple electrode plates 30 are laminated with the separators 33 interposed therebetween, in other words, where the positive electrode plates 31 and the negative electrode plates 32 are alternately laminated with the separators 33 interposed therebetween. Each positive electrode plate 31 includes a positive electrode active material layer 31a including a metal positive electrode core and a positive electrode active material disposed over the positive electrode core. Examples of the material of the positive electrode core include metal foil that is stable within a potential range of the positive electrode plate 31 such as aluminum, and a film including the metal on the outer surface layer. The positive electrode core has a thickness of, for example, 10 to 20 μm. Each negative electrode plate 32 includes a negative electrode active material layer 32a including a metal negative electrode core and a negative electrode active material disposed on the negative electrode core. Examples of the material of the negative electrode core include a metal foil that is stable within a potential range of a negative electrode plate such as copper, and a film including the metal on the outer surface layer. The negative electrode core has a thickness of, for example, 5 to 15 μm. In the secondary battery 100, preferably, the positive electrode plate 31 has a size slightly smaller than the size of the negative electrode plate 32.

The electrode tabs 4 protrude from first ends of the multiple electrode plates 30 forming the multilayer electrode body 3. In other words, the positive electrode tabs 5 protrude from the first ends of the positive electrode plates 31 and the negative electrode tabs 6 protrude from the first ends of the negative electrode plates 32. The positive electrode plates 31 have the positive electrode tabs 5 at substantially the same position Thus, the positive electrode tabs 5 are arranged in a line in a lamination direction in the multilayer electrode body 3. Similarly, the negative electrode plates 32 have the negative electrode tabs 6 at substantially the same position Thus, the negative electrode tabs 6 are arranged in a line in the lamination direction in the multilayer electrode body 3.

Examples usable as the material of the positive electrode tabs 5 include metal foil that is stable within a potential range of the positive electrode plate 31 such as aluminum, and a film including the metal on the outer surface layer. The positive electrode tabs 5 have a thickness of, for example, 10 to 20 μm. Examples of the material of the negative electrode tabs 6 include metal foil that is stable within a potential range of a negative electrode plate such as copper, and a film including the metal on the outer surface layer. The negative electrode core has a thickness of, for example, 5 to 15 μm. In the present embodiment, different electrically conductive members are respectively connected to the positive electrode core and the negative electrode core to form the positive electrode tabs 5 and the negative electrode tabs 6. Each positive electrode tab 5 may be formed by extending the positive electrode core, or each negative electrode tab 6 may be formed by extending the negative electrode core. At the base portion of each positive electrode tab 5, an insulating layer or a protective layer that is more highly electrically resistant than the positive electrode core may be disposed.

Preferably, each positive electrode active material layer 31a includes a positive electrode active material, a conductive aid such as carbon, and a binder such as polyvinylidene fluoride (PVdF), and is preferably disposed on each of both surfaces of the positive electrode core. The positive electrode plate 31 can be fabricated by coating the positive electrode core with positive electrode active material slurry including a positive electrode active material, a conductive aid, and a binder, drying the coating and then compressing the coating with, for example, a roller to form the positive electrode active material layers 31a on both surfaces of the positive electrode core. The positive electrode active material layer 31a may be disposed on only one surface of the positive electrode core.

Examples usable as the positive electrode active material include a lithium-metal compound oxide. Examples of a metallic element contained in the lithium-metal compound oxide include Ni, Co, Mn, Al, B, Mg, Ti, V, Cr, Fe, Cu, Zn, Ga, Sr, Zr, Nb, In, Sn, Ta, and W. A preferable example of the lithium-metal compound oxide is a lithium-metal compound oxide containing at least one of Ni, Co, and Mn. Specific examples include a lithium-metal compound oxide containing Ni, Co, and Mn and a lithium-metal compound oxide containing Ni, Co, and Al. Particles of an inorganic compound such as a tungsten oxide, an aluminium oxide, or a lanthanoid compound may adhere to the particle surface of the lithium-metal compound oxide.

Preferably, the negative electrode active material layer 32a includes a negative electrode active material, a binder such as styrene-butadiene rubber (SBR), and a thickener such as carboxymethyl cellulose (CMC), and is disposed on each of both surfaces of the negative electrode core. The negative electrode plate 32 can be fabricated by coating the negative electrode core with negative electrode active material slurry including a negative electrode active material and a binder, drying the coating, and then compressing the coating with, for example, a roller, to form the negative electrode active material layers 32a on both surfaces of the negative electrode core. The negative electrode active material layer 32a may be disposed on only one surface of the negative electrode core.

Examples of the negative electrode active material include natural graphite such as flaky graphite, lump graphite, and earthy graphite and artificial graphite such as lump artificial graphite and graphitized mesophase carbon microbeads. Examples of the negative electrode active material may include metal alloyed with lithium such as Si or Sn, an alloy containing such metal, and compounds containing such metal, and such a material may be used together with graphite. Examples of such a compound include a silicon compound expressed in SiOₓ (0.5≤x≤1.6).

A porous sheet having ion permeability and insulation properties is used as each separator 33. Preferably, the separator 33 includes, for example, a porous substrate containing, as a main component, at least one selected from the group consisting of polyolefin, polyvinylidene fluoride, polytetrafluoroethylene, polyimide, polyamide, polyamide-imide, polyether sulfone, polyether-imide, and aramid. Here, polyolefin is preferable, and polyethylene and polypropylene are particularly preferable. The separators 33 may be formed from only a resin-made porous substrate, or may have a multilayer structure including a heatproof layer including inorganic particles on at least one surface of the porous substrate. The resin-made porous substrate may have a multilayer structure of, for example, polypropylene, polyethylene, and polypropylene. The separator 33 has, for example, an average pore size of 0.02 to 5 μm, and a porosity of 30 to 70%.

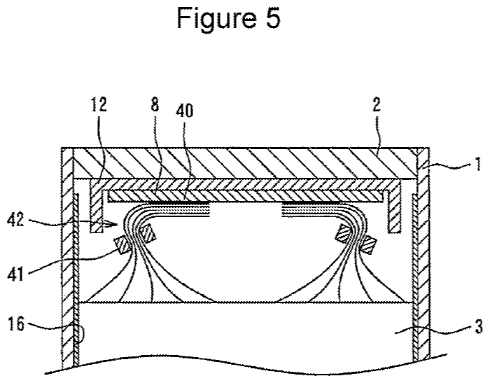

FIG. 4 is an enlarged cross-sectional view of a portion around the positive electrode tabs 5. In FIGS. 4 and 5, the binding members 41 will be described. Here, a case where the binding members 41 are disposed on the positive electrode tabs 5 will be described. Also in the case where the negative electrode tabs 6 have a similar structure, the same effects can be naturally obtained. Preferably, the binding members 41 are disposed on both the positive electrode tabs 5 and the negative electrode tabs 6. The multiple positive electrode tabs 5 protruding from first ends of the positive electrode plates 31 are connected to the positive electrode collector 8 with the connector 40. The multiple positive electrode tabs 5 are bound by the binding member 41 between the connector 40 and the multilayer electrode body 3 to prevent the positive electrode tabs 5 from being shifted from and rubbed against each other and worn out due to vibrations or shocks from the exterior. Particularly, when the positive electrode tabs 5 are formed from metal foil, burrs may occur on both edges of the positive electrode tabs 5 in the width direction (left and right sides of the positive electrode tabs 5 in FIG. 4), and thus the positive electrode tabs 5 would be heavily worn when rubbed against each other. Thus, the binding member 41 has a remarkable effect.

With reference to FIG. 5, a preferable form of the binding member 41 will be described. FIG. 5 is an enlarged cross-sectional view of a portion around the positive electrode tabs 5 in a cross section taken along line B-B in FIG. 2. The multiple positive electrode tabs 5 protruding from the upper portion of the multilayer electrode body 3 are arranged in a line at regular intervals and divided into two groups at substantially the middle in the lamination direction. The groups are respectively gathered toward the side closer to the front and the side further from the front in the lamination direction (to the left and right sides in FIG. 5), and connected by welding to the positive electrode collector 8 with the connector 40. Portions of the multiple positive electrode tabs 5 fixed together by, for example, welding with the connector 40 are prevented from being rubbed against each other. However, when the multilayer electrode body 3 moves between the connector 40 and the multilayer electrode body 3 in the lamination direction in response to vibrations or shocks from the exterior, the positive electrode tabs 5 are rubbed against each other at portions where the distance between the positive electrode tabs 5 is narrow. The multilayer electrode body 3 occupies a large part of the capacity inside the battery case 20 for increasing the capacity of the secondary battery 100. Thus, the multilayer electrode body 3 and the positive electrode collector 8 are located close to each other, and the positive electrode tabs 5 are largely bent at bent portions 42. The positive electrode tabs 5 bent in the lamination direction reduce the distance between each other at the bent portions 42. Thus, the positive electrode tabs 5 are more likely to be particularly rubbed against each other at the bent portions 42, and some of the positive electrode tabs 5 are likely to suffer a stress concentration.

The multiple positive electrode tabs 5 have bent portions 42, and each of the binding members 41 can bind the multiple positive electrode tabs 5 at the bent portions 42. At the bent portions 42, the positive electrode tabs 5 are located close to each other, and are more likely to be rubbed against each other in response to vibrations or shocks from the exterior. Some of the positive electrode tabs 5 are likely to suffer a stress concentration. Binding the positive electrode tabs 5 with the binding members 41 at the bent portions 42 can prevent the positive electrode tabs 5 from being worn out at the bent portions 42 and some of the positive electrode tabs 5 from suffering a stress concentration.

Each binding member 41 can form a structure of clamping the multiple positive electrode tabs 5 with a resin member. A resin member (the binding member 41) according to an example of the embodiment illustrated in FIGS. 4 and 5 has a rectangular shape longer than the width of the positive electrode tab 5, and clamps the positive electrode tabs 5 while having both ends of the resin member bonded together by, for example, thermal bonding. Instead of a rectangular shape, the resin member may have any shape capable of clamping the positive electrode tabs 5, such as a curved shape. Even when the resin member is broken and detached from the positive electrode tabs 5 due to some causes, the resin member does not cause unintended electric conduction. Thus, the battery can improve the reliability. The resin member is not limited to a particular one and may be any resin member having insulation properties. For example, polyethylene, polypropylene, and polyfluoroethylene are usable as the resin member.

The binding member 41 may have a structure of bonding the multiple positive electrode tabs 5 with an adhesive. As an example of the embodiment, the multiple positive electrode tabs 5 may be bonded together at the bent portions 42 with an adhesive. Bonding the positive electrode tabs 5 with an adhesive prevents the positive electrode tabs 5 from being rubbed against each other at the bent portions 42. The adhesive is not limited to a particular one and may be any adhesive capable of bonding the multiple positive electrode tabs 5 together. For example, an acrylic or epoxy thermosetting resin adhesive may be used. This structure may be used together with the structure where the above-described resin member is used to clamp the positive electrode tabs 5.

A first end of the binding member 41 may be fixed to the sealing plate 2. Here, the binding member 41 fixed to the sealing plate 2 hinders the positive electrode tabs 5 from moving in response to vibrations or shocks from the exterior, and thus more reliably prevents the positive electrode tabs 5 from being rubbed against each other. Instead, a first end of the binding member 41 may be fixed to the sealing plate 2 with the internal insulating member 12 or 14. Examples of a fixing method include a method for fixing the binding member 41 to the internal insulating member 12 or 14 by bonding, fitting, or swaging, and a method for integrally forming the resin member of the binding member 41 with the internal insulating member 12 or 14. When the internal insulating member 12 or 14 and the binding member 41 are both formed from resin, the binding member 41 can be easily bonded to the internal insulating member 12 or 14, or can be easily integrally formed with the internal insulating member 12 or 14.

### Examples

The present disclosure will be further described below with examples, but the present disclosure is not limited to these examples.

### Examples

LiNi_{0.5}Co_{0.2}Mn_{0.3}O₂ serving as a positive electrode active material, polyvinylidene fluoride (PVdF) serving as a binder and carbon serving as an electrically conductive material were mixed at the weight ratio of 92:4:4, and the mixture was dispersed in N-Methyl-2-pyrrolidone to prepare positive electrode mixture slurry. This slurry was coated on aluminium foil with a thickness of 15 μm serving as a positive electrode core, dried, compressed with a roller, and cut into a predetermined electrode size to fabricate a positive electrode having a square positive electrode core and positive electrode mixture layers on both surfaces of the positive electrode core. The positive electrode core was exposed at an end of the positive electrode to form the positive electrode tab.

Natural graphite serving as a negative electrode active material, styrene-butadiene rubber (SBR) serving as a binder and carboxymethyl cellulose were mixed at the weight ratio of 96:2:2, and the mixture was dispersed in water to prepare negative electrode mixture slurry. This slurry was coated on copper foil with a thickness of 10 μm serving as a negative electrode core, dried, compressed with a roller, and cut into a predetermined electrode size to fabricate a negative electrode having a square negative electrode core and negative electrode mixture layers on both surfaces of the negative electrode core. The negative electrode core was exposed at an end of the negative electrode to form the negative electrode tab.

A negative electrode plate, polyethylene serving as a separator, and a positive electrode plate were laminated in this order multiple times to fabricate a multilayer electrode body. The fabricated multilayer electrode body was inserted into an open-top box-shaped insulating sheet. The positive electrode tabs and the negative electrode tabs of the multilayer electrode body were respectively connected to the positive electrode terminal and the negative electrode terminal attached to the sealing plate, and this structure was inserted into the rectangular exterior body once to check the position of the bent portions where the positive electrode tabs and the negative electrode tabs are bent. A pair of resin members were pressed against the positive electrode tabs or the negative electrode tabs to hold the tabs at the bent portions to fix the tabs with thermal bonding. Thereafter, the opening of the exterior body was sealed with a sealing plate to fabricate a secondary battery.

Herein, a vibration test described later was conducted without an injection of an electrolyte. In a case where the test is conducted without an injection of an electrolyte, the multilayer electrode body more easily moves in response to vibrations or shocks from the exterior than when the test is conducted with an injection of an electrolyte. Thus, the test conducted without an injection of an electrolyte has severer conditions.

### Comparative Example

A secondary battery was fabricated in a similar manner except that no binding member was provided.

### <Vibration Test>

The vibration test was conducted on the secondary batteries according to the example and the comparative example while vibrating each multilayer electrode body in the lamination direction. In the vibration test, each secondary battery was vibrated while changing the wave numbers by logarithmic sine sweep with a peak acceleration of 10 G and at 25 Hz for a predetermined period in one vibration test cycle. After the excitation, the positive electrode tabs and the negative electrode tabs were examined for damages once every 50-thousand cycles through X-ray inspected images, and evaluated with the number of cycles at which damages were found.

Table 1 shows the results for the secondary batteries according to the example and comparative example. The values shown in table 1 are relative values where the number of cycles at which damages were found is defined as 1.

TABLE 1

| | Example | Comparative Example |
|---|---|---|
| Number of Cycles at Which | 4.9 | 1 |
| Damages Were Found | | |

As is clear from table 1, the example where the electrode tabs were bound with the binding member had durability of 4.9 times of that of the comparative example including no binding member. Thus, in a secondary battery including a multilayer electrode body obtained by laminating multiple electrode plates with a separator interposed in between and including multiple electrode tabs protruding from the multiple electrode plates, an exterior body having an opening receiving the multilayer electrode body, a sealing plate that closes the opening, a collector disposed on the sealing plate and connected to the multiple electrode tabs, and a binding member that binds the multiple electrode tabs, the electrode tabs can be prevented from being broken.

### REFERENCE SIGNS LIST

1 exterior body
2 sealing plate
3 multilayer electrode body
4 electrode tab,
5 positive electrode tab
6 negative electrode tab
7 collector
8 positive electrode, collector
9 negative electrode, collector
10 positive electrode terminal
11 negative electrode terminal
12, 14 internal insulating member
13, 15 external insulating member
16 insulating sheet
17 electrolyte injection hole
18 stopcock
19 gas exhaust valve
20 battery case
30 electrode plate
31 positive electrode plate
31a positive electrode active material layer
32 negative electrode plate
32a negative electrode, active material layer
33 separator
40 connector
41 binding member
42 bent portion
100 secondary battery

1. A secondary battery, comprising:
a multilayer electrode body obtained by laminating a plurality of electrode plates with a separator interposed in between,
a plurality of electrode tabs protruding from first ends of the plurality of electrode plates,
an exterior body having an opening receiving the multilayer electrode body,
a sealing plate that closes the opening,
a collector disposed on the sealing plate and connected to the plurality of electrode tabs with a connector, and
a binding member that binds the plurality of electrode tabs between the connector and the multilayer electrode body.

2. The secondary battery according to claim 1,
wherein the plurality of electrode tabs have bent portions, and
wherein the binding member binds the plurality of electrode tabs together at the bent portions.

3. The secondary battery according, to claim 1, wherein the binding member has a mechanism of clamping the plurality of electrode tabs with a resin member.

4. The secondary battery according, to claim 1, wherein the binding member has a mechanism of bonding the plurality of electrode tabs together with an adhesive.

5. The secondary battery according to claim 1, wherein a first end of the binding member is fixed to the sealing plate.
